(19) United States
(12) Patent Application Publication
(10) Pub. No.: US 2026/0339140 A1
(43) Pub. Date: Oct. 29, 2026

(54) TILING DISPLAY APPARATUS

(71) Applicant: AUO Corporation, Hsinchu City (TW)

(72) Inventors: Chia-Jung Wu, Hsinchu City (TW); Ti-Kuei Yu, Hsinchu City (TW); Ya-Ling Hsu, Hsinchu City (TW)

(73) Assignee: AUO Corporation, Hsinchu City (TW)

(21) Appl. No.: 19/317,155

(22) Filed: Sep. 3, 2025

(30) Foreign Application Priority Data
Apr. 28, 2025 (TW) 114116008

(51) Int. Cl. G02F 1/1333

(52) U.S. Cl. CPC G02F 1/13336

(57) ABSTRACT

A tiling display apparatus including at least two display panels and at least one camera unit is provided. The at least two display panels are spliced with each other along at least one direction. Each of the at least two display panels has a first splicing edge for splicing and is provided with a non-self-emissive display area and a self-emissive display area. The self-emissive display area extends from the first splicing edge to the non-self-emissive display area. Each of the at least two display panels includes a display medium layer and a plurality of light-emitting elements. The display medium layer is disposed in the non-self-emissive display area. The plurality of light-emitting elements are disposed in the self-emissive display area. The at least one camera unit is disposed in the self-emissive display areas of the at least two display panels.

### CROSS-REFERENCE TO RELATED APPLICATION

This application claims the priority benefit of Taiwan application serial no. 114116008, filed on Apr. 28, 2025. The entirety of the above-mentioned patent application is hereby incorporated by reference herein and made a part of this specification.

### BACKGROUND

### Technical Field

The disclosure relates to a display apparatus, and more particularly to a tiling display apparatus.

### Description of Related Art

To meet the demand for users to display various shared information and integrated information over a large area, tiling display apparatuses integrating a plurality of display panels have been widely applied in various fields. For example, tiling display apparatuses are commonly found in public information display fields, such as large-scale advertisements and surveillance management screens. To enhance interaction with the public, the tiling display apparatus may further be provided with a camera unit. However, tiling display apparatuses often have an issue of discontinuity in the overall displayed image, which affects viewing quality. Moreover, the installation of the camera unit may easily increase the surrounding layout space and impair aesthetics.

### SUMMARY

The disclosure provides a tiling display apparatus having improved image continuity in the spliced display, and in which a camera unit disposed adjacent to a splicing portion can have better concealment.

A tiling display apparatus of the disclosure includes at least two display panels and at least one camera unit. The at least two display panels are spliced with each other along at least one direction. Each of the at least two display panels has a first splicing edge for splicing and is provided with a non-self-emissive display area and a self-emissive display area. The self-emissive display area extends from the first splicing edge to the non-self-emissive display area. Each of the at least two display panels includes a display medium layer and a plurality of light-emitting elements. The display medium layer is disposed in the non-self-emissive display area. The plurality of light-emitting elements are disposed in the self-emissive display area. The at least one camera unit is disposed in the self-emissive display areas of the at least two display panels.

Based on the above, in a tiling display apparatus of an embodiment of the disclosure, two adjacent display panels are respectively provided with a plurality of light-emitting elements in areas adjacent to the splicing edge. The arrangement of the light-emitting elements can significantly improve the continuity of the display images of the two display panels at the splicing portion. In addition, by disposing the camera unit within the distribution areas of the light-emitting elements, the concealment of the camera unit can be effectively enhanced.

### BRIEF DESCRIPTION OF THE DRAWINGS

FIG. 1 is a schematic front view of a tiling display apparatus according to a first embodiment of the disclosure.

FIG. 2 is a schematic cross-sectional view of the display panel of FIG. 1.

FIG. 3 and FIG. 4 are schematic front views of partial film layers of the display panel of FIG. 1.

FIG. 5 and FIG. 6 are enlarged schematic diagrams of a partial region of the display panel of FIG. 1.

FIG. 7 is a schematic front view of a tiling display apparatus according to a second embodiment of the disclosure.

FIG. 8 and FIG. 9 are enlarged schematic diagrams of a partial region of the display panel of FIG. 7.

FIG. 10 is a schematic front view of a tiling display apparatus according to a third embodiment of the disclosure.

FIG. 11 is a schematic front view of a tiling display apparatus according to a fourth embodiment of the disclosure.

### DESCRIPTION OF THE EMBODIMENTS

As used herein, the terms “approximately,” “about,” “substantially,” or “essentially” include the stated values as well as average values within an acceptable deviation range as would be determined by a person skilled in the art, taking into account specific quantities of measurement and the errors associated with measurement (i.e., limitations of the measurement system). For example, “about” may refer to within one or more standard deviations from the stated value, or within ±30%, ±20%, ±15%, ±10%, or ±5%. Furthermore, depending on the nature of the measurement, cutting process, or other relevant properties, the terms “approximately,” “about,” “substantially,” or “essentially” may be interpreted with a selectively acceptable deviation range or standard deviation, and a single standard deviation does not necessarily apply to all properties.

In the drawings, for clarity, the thicknesses of layers, films, panels, and regions are exaggerated. It should be understood that when components such as layers, films, regions, or substrates are described as being “on” or “connected to” another component, they may be directly on or connected to the other component, or intermediate components may also be present. Conversely, when components are described as being “directly on” or “directly connected to” another component, no intermediate components are present. As used herein, “connected” may refer to physical and/or electrical connection. Additionally, “electrically connected” may still allow for other components to exist between the two elements.

Moreover, relative terms such as “lower” or “bottom” and “upper” or “top” may be used herein to describe the relationship between components as shown in the FIG.s. It should be understood that such relative terms are intended to encompass different orientations of the device beyond those shown in the drawings. For example, if a device in a drawing is flipped, the component described as being “below” another component may now be positioned “above” it. Thus, exemplary terms such as “lower” may include both “lower” and “upper” orientations, depending on the specific orientation in the FIG.s. Similarly, a component described as being “under” or “beneath” another may also be situated “over” or “above” it if the FIG. is flipped. Therefore, exemplary terms like “above” or “below” may include both orientations.

The exemplary embodiments described herein are referenced to schematic cross-sectional views, which are idealized examples. Variations in the illustrated shapes due to, for example, manufacturing techniques and/or tolerances are to be expected. Therefore, the embodiments described herein should not be construed as limited to the specific shapes illustrated, but rather include shape deviations that result from manufacturing. For instance, regions shown or described as flat may exhibit rough and/or nonlinear characteristics. Additionally, sharp corners shown in the drawings may in reality be rounded. As such, the regions illustrated in the FIG. s are essentially schematic and are not intended to depict exact shapes, nor to limit the scope of the claimed disclosure.

Detailed reference will now be made to exemplary embodiments of the present disclosure, examples of which are illustrated in the accompanying drawings. Wherever possible, the same reference numerals are used throughout the drawings and description to refer to the same or like parts.

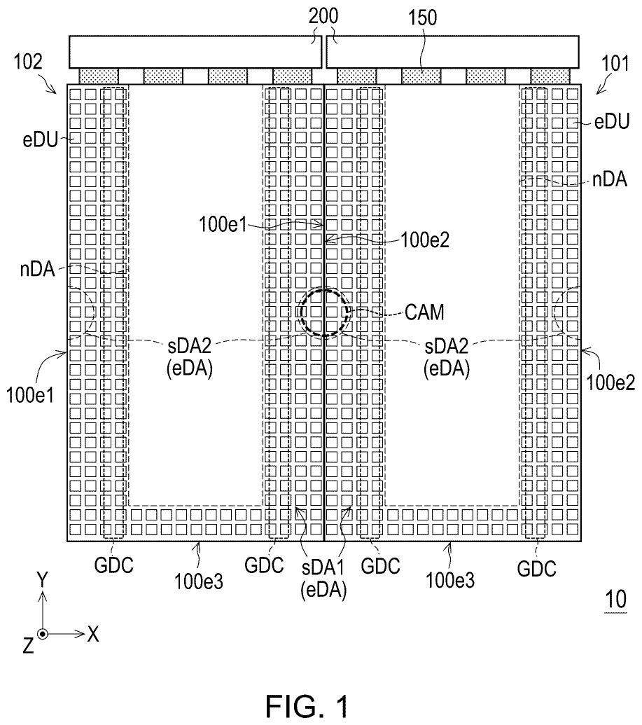

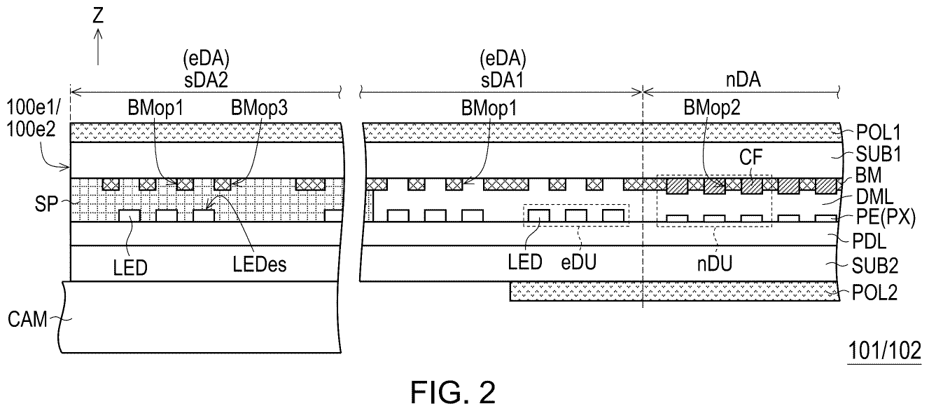

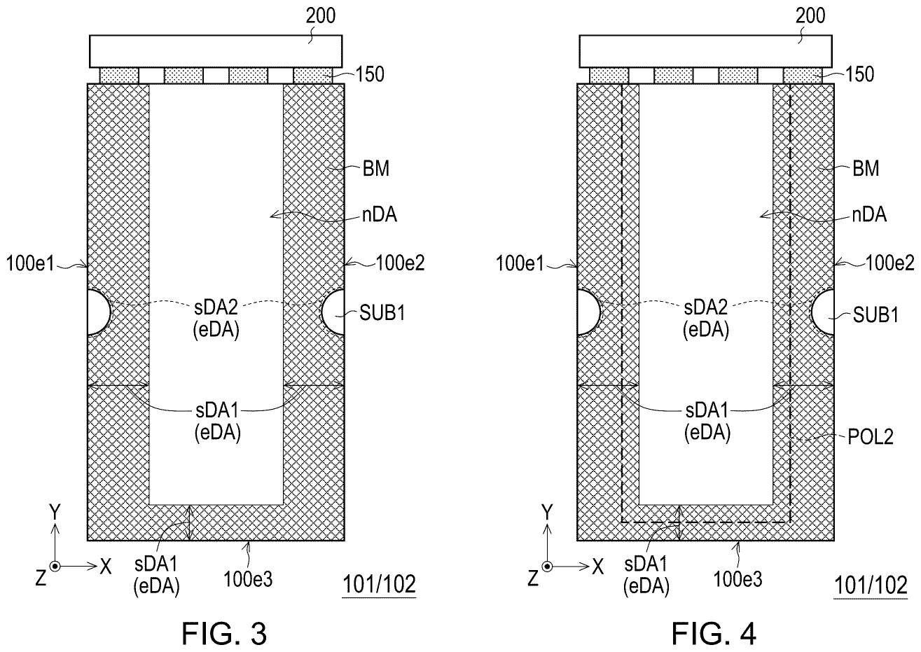

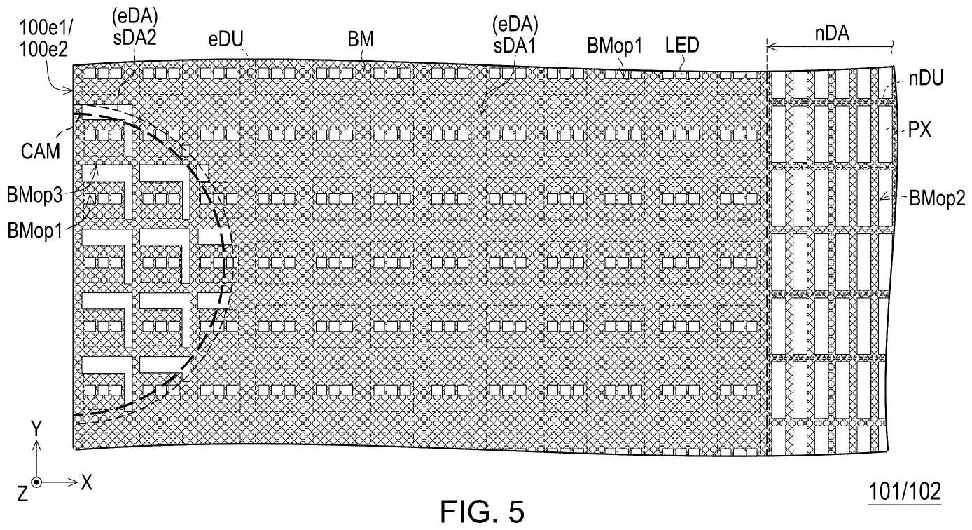

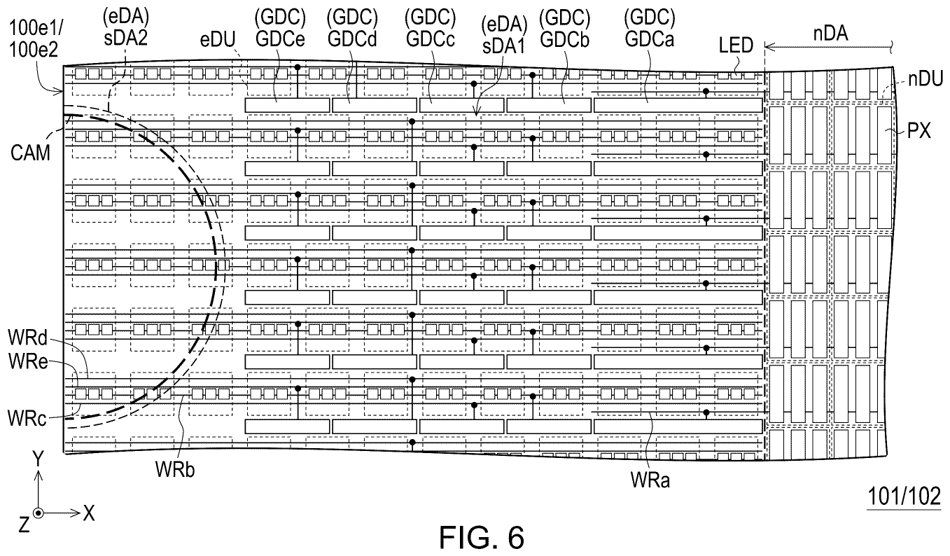

FIG. 1 is a schematic front view of a tiling display apparatus according to a first embodiment of the disclosure. FIG. 2 is a schematic cross-sectional view of the display panel of FIG. 1. FIG. 3 and FIG. 4 are schematic front views of partial film layers of the display panel of FIG. 1. FIG. 5 and FIG. 6 are enlarged schematic diagrams of a partial region of the display panel of FIG. 1.

Referring to FIG. 1, a tiling display apparatus 10 includes a display panel 101, a display panel 102, and a camera unit CAM. The display panel 101 and the display panel 102 are spliced with each other along a direction (for example, direction X), and each has a splicing edge 100e1, a splicing edge 100e2, and a splicing edge 100e3 for splicing. The splicing edge 100e1 and the splicing edge 100e2 are opposite to each other and are connected to opposite ends of the splicing edge 100e3, respectively. An extending direction of the splicing edge 100e3 intersects an extending direction of each of the splicing edge 100e1 and the splicing edge 100e2. For example, in the embodiment, the display panel 101 is spliced with the splicing edge 100e2 of the display panel 102 via the splicing edge 100e1 and along the direction X. In another embodiment, each of the display panel 101 and the display panel 102 may further be spliced with another display panel via the splicing edge 100e3 along a direction Y.

In the embodiment, the camera unit CAM overlaps a splicing portion of the display panel 101 and the display panel 102 along a front view direction (for example, direction Z) of the tiling display apparatus 10. That is, the camera unit CAM overlaps the splicing edge 100e1 of the display panel 101 and the splicing edge 100e2 of the display panel 102. Hereinafter, unless otherwise specified, the overlapping relationship between two components is defined along the front view direction of the tiling display apparatus 10, and the overlapping direction will not be repeated.

Furthermore, the display panel 101 and the display panel 102 are each provided with a non-self-emissive display area nDA and a self-emissive display area eDA. The self-emissive display area eDA extends from the three splicing edges 100e1, 100e2, and 100e3 to the non-self-emissive display area nDA. More specifically, in the embodiment, the self-emissive display area eDA extends on three sides of the non-self-emissive display area nDA.

Referring to FIG. 1 and FIG. 2, each of the display panel 101 and the display panel 102 may include a substrate SUB1, a substrate SUB2, a display medium layer DML, and a plurality of light-emitting elements LED. The substrate SUB1 and the substrate SUB2 are stacked along the direction Z (i.e., the front view direction of the tiling display apparatus 10) and opposite each other. The display medium layer DML and the plurality of light-emitting elements LED are disposed between the substrate SUB1 and the substrate SUB2. The display medium layer DML is disposed in the non-self-emissive display area nDA, and the plurality of light-emitting elements LED are disposed in the self-emissive display area eDA. In other words, a distribution region of the light-emitting elements LED defines the self-emissive display area eDA of the display panel.

In the embodiment, the substrate SUB1 and the substrate SUB2 may be assembled with each other via a sealant pattern SP to form an accommodating space for filling the display medium layer DML. It is particularly noted that the plurality of light-emitting elements LED are also disposed in the accommodating space defined by the substrate SUB1, the substrate SUB2, and the sealant pattern SP. More specifically, the display medium layer DML of the embodiment may further extend into the self-emissive display area eDA and cover the plurality of light-emitting elements LED. In the embodiment, the display medium layer DML is, for example, a liquid crystal layer.

A plurality of non-self-emissive display units nDU may be disposed in the non-self-emissive display area nDA. In the embodiment, each of the non-self-emissive display units nDU may include three pixel structures PX for driving the display medium layer DML. The three pixel structures PX may be disposed on the substrate SUB2, and each includes an active element (not shown) and a pixel electrode PE electrically connected to each other. For example, a pixel driving layer PDL may be disposed on the substrate SUB2. The pixel driving layer PDL may be provided with the active elements of the pixel structures PX, and the pixel electrode PE is formed on the pixel driving layer PDL. A common electrode (not shown) may be disposed on the substrate SUB1 or the substrate SUB2. An electric field generated between the pixel electrode PE and the common electrode is used to drive a plurality of liquid crystal molecules (not shown) of the liquid crystal layer (i.e., the display medium layer DML) to rotate, thereby forming a liquid crystal alignment state corresponding to the electric field strength. The liquid crystal alignment state under different electric field strengths can modulate the polarization state of polarized light passing through the liquid crystal layer to change the light intensity of the polarized light, thereby achieving a display effect of different grayscale levels.

To achieve a color display effect in the non-self-emissive display area nDA, each of the non-self-emissive display units nDU may further be provided three color filter patterns CF disposed on the substrate SUB1. The three color filter patterns CF respectively overlap the three pixel structures PX along the direction Z and are adapted to allow three different color lights (for example, red light, green light, and blue light) to pass through.

On the other hand, a plurality of self-emissive display units eDU composed of the plurality of light-emitting elements LED may be provided in the self-emissive display area eDA. For example, in the embodiment, each of the self-emissive display units eDU may include three light-emitting elements LED, and the three light-emitting elements LED may emit three different color lights, such as red light, green light, and blue light, but the disclosure is not limited thereto. The light-emitting elements LED may be, for example, micro light-emitting diodes (micro-LEDs) or mini light-emitting diodes (mini-LEDs), but the disclosure is not limited thereto. In the embodiment, the pixel driving layer PDL may further be provided with a plurality of pixel circuits (not shown). The pixel circuits are electrically connected to the plurality of light-emitting elements LED and are configured to drive the light-emitting elements LED to emit light with different or identical grayscale brightness levels.

Since the display panel 101 and the display panel 102 are respectively provided with a plurality of light-emitting elements LED in regions adjacent to the splicing edges, the continuity of the display image at the splicing portion of the two display panels 101 and 102 can be greatly improved.

Furthermore, the display panel 101 and the display panel 102 may each further include a light-shielding layer BM disposed on the substrate SUB1 and located in the non-self-emissive display area nDA and the self-emissive display area eDA. In the embodiment, the light-shielding layer BM has a plurality of openings BMop1 located in the self-emissive display area eDA and a plurality of openings BMop2 located in the non-self-emissive display area nDA. In a stacking direction (for example, direction Z) of the substrate SUB1 and the substrate SUB2, the plurality of openings BMop1 respectively overlap the plurality of light-emitting elements LED, and the plurality of openings BMop2 respectively overlap the plurality of pixel structures PX. A plurality of color filter patterns CF may be respectively disposed in the plurality of openings BMop2 of the light-shielding layer BM.

In the embodiment, the self-emissive display area eDA may include a first sub-display area sDA1 and two second sub-display areas sDA2. One of the second sub-display areas sDA2 is located between the first sub-display area sDA1 and the splicing edge 100e1, and the other second sub-display area sDA2 is located between the first sub-display area sDA1 and the splicing edge 100e2. More specifically, the first sub-display area sDA1 is continuously distributed on the left side, the right side, and the lower side of the non-self-emissive display area nDA in FIG. 1 and is spaced apart from the splicing edge 100e1 and the splicing edge 100e2.

It should be particularly noted that the camera unit CAM is disposed on one side of the substrate SUB2 facing away from the display medium layer DML. In the embodiment, the camera unit CAM overlaps the second sub-display areas sDA2 of the self-emissive display area eDA of each of the display panel 101 and the display panel 102, and does not overlap the first sub-display areas sDA1 of the self-emissive display area eDA of each of the display panel 101 and the display panel 102. That is, the camera unit CAM overlaps part of the plurality of light-emitting elements LED in the self-emissive display area eDA. Accordingly, the concealment of the camera unit CAM can be effectively increased. The camera unit CAM may include, for example, a charge-coupled device (CCD) or a complementary metal-oxide-semiconductor (CMOS) element, but the disclosure is not limited thereto.

In order to allow the camera unit CAM to capture an image of an object or a person located in front of the tiling display apparatus 10 through the two display panels 101 and 102, an aperture ratio of the light-shielding layer BM in the second sub-display area sDA2 may be greater than its aperture ratio in the first sub-display area sDA1. Referring to FIG. 2 and FIG. 5, for example, in the embodiment, the light-shielding layer BM may further have a plurality of openings BMop3 located in the second sub-display area sDA2.

From another perspective, the aperture ratio of the light-shielding layer BM in the second sub-display area sDA2 and the aperture ratio of the light-shielding layer BM in the non-self-emissive display area nDA are both significantly greater than the aperture ratio of the light-shielding layer BM in the first sub-display area sDA1 (as shown in FIG. 5). Therefore, for clarity, FIG. 3 only illustrates a portion of the light-shielding layer BM located in the first sub-display area sDA1. For example, in the embodiment, the light-shielding layer BM in the second sub-display area sDA2 only retains portions for shielding pixel circuits and signal lines (for example, power lines for transmitting a system high potential VDD or a system low potential VSS, but the disclosure is not limited thereto) electrically connected to the light-emitting elements LED, and the light-shielding layer BM in the non-self-emissive display area nDA only retains portions for shielding signal lines (not shown) and active elements (not shown) of the pixel structures PX.

In contrast, the light-shielding layer BM in the first sub-display area sDA1 exposes only the light-emitting surfaces LEDes of the plurality of light-emitting elements LED. That is, in the first sub-display area sDA1, areas other than the light-emitting surfaces LEDes of the plurality of light-emitting elements LED are all shielded by the light-shielding layer BM. Referring to FIG. 2, FIG. 5, and FIG. 6, therefore, a plurality of gate driving circuits GDC and a plurality of signal lines (not shown, for example, signal lines for transmitting a scan start signal or a clock signal, but the disclosure is not limited thereto) may further be disposed in the first sub-display area sDA1 of the self-emissive display area eDA, and the gate driving circuits GDC and the signal lines do not overlap the second sub-display areas sDA2.

In the embodiment, the plurality of gate driving circuits GDC may include a plurality of gate driving circuits GDCa, a plurality of gate driving circuits GDCb, a plurality of gate driving circuits GDCc, a plurality of gate driving circuits GDCd, and a plurality of gate driving circuits GDCe. The plurality of gate driving circuits GDCa may be electrically coupled to the plurality of pixel structures PX via a plurality of signal lines WRa. The plurality of gate driving circuits GDCb may be electrically coupled to a plurality of pixel circuits for driving the plurality of light-emitting elements LED via a plurality of signal lines WRb. The plurality of gate driving circuits GDCc may be electrically coupled to a plurality of pixel circuits for driving the plurality of light-emitting elements LED via a plurality of signal lines WRc. The plurality of gate driving circuits GDCd may be electrically coupled to a plurality of pixel circuits for driving the plurality of light-emitting elements LED via a plurality of signal lines WRd. The plurality of gate driving circuits GDCe may be electrically coupled to a plurality of pixel circuits for driving the plurality of light-emitting elements LED via a plurality of signal lines WRe. For example, the gate driving circuit GDCb, the gate driving circuit GDCc, the gate driving circuit GDCd, and the gate driving circuit GDCe may respectively provide a scan signal of a reset circuit, a scan signal of a write circuit, and at least two light-emitting signals of the three light-emitting elements LED for each pixel circuit in the self-emissive display unit eDU, but the disclosure is not limited thereto.

It should be particularly noted that the plurality of gate driving circuits GDC described above may be formed in the pixel driving layer PDL. That is, the plurality of gate driving circuits GDCb to GDCe for driving the plurality of light-emitting elements LED and the plurality of gate driving circuits GDCa for driving the plurality of pixel structures PX are formed on the same substrate SUB2. Therefore, the bonding process between a plurality of gate ICs and the display panel can be omitted, which not only reduces manufacturing costs but also helps to realize a narrow bezel design of the display panel.

However, the disclosure is not limited thereto. In other embodiments, the plurality of gate driving circuits GDC, the plurality of signal lines WRa to WRe, and the plurality of signal lines described above may not be disposed in the first sub-display area sDA1.

Referring to FIG. 2 and FIG. 4, in the embodiment, the display panel 101 and the display panel 102 may each further include a polarizer POL1 and a polarizer POL2. For example, the polarizer POL1 may be attached to one side of the substrate SUB1 facing away from the display medium layer DML, and the polarizer POL2 may be attached to one side of the substrate SUB2 facing away from the display medium layer DML. That is, the display medium layer DML is located between the polarizer POL1 and the polarizer POL2.

The polarizer POL1 and the polarizer POL2 overlap the non-self-emissive display area nDA. It should be particularly noted that the polarizer POL1 may further extend to the second sub-display area sDA2 to further enhance the concealment of the camera unit CAM. More specifically, in the embodiment, the polarizer POL1 may be entirely attached to the substrate SUB1. On the other hand, in consideration of the attachment accuracy of the polarizer POL2 on the substrate SUB2, the polarizer POL2 of the embodiment may further extend to the first sub-display area sDA1 of the self-emissive display area eDA, and does not overlap the second sub-display area sDA2. That is, the first sub-display area sDA1 may also serve as a buffer zone for the polarizer POL2 during the attachment process. It should be understood that, in another embodiment, if the attachment accuracy of the polarizer POL2 is sufficiently high, the edge of the polarizer POL2 may be generally aligned with the boundary of the non-self-emissive display area nDA.

Referring to FIG. 1, in the embodiment, the tiling display apparatus 10 may further include a plurality of flexible circuit boards 150 and two driving circuit boards 200. Each of the display panel 101 and the display panel 102 may be electrically coupled to the driving circuit boards 200 via the bonding of the plurality of flexible circuit boards 150, but the disclosure is not limited thereto. More specifically, the driving circuit boards 200 are bonded to one side of the display panel opposite to the splicing edge via the plurality of flexible circuit boards 150.

Another embodiment will be listed below to describe the disclosure in detail, wherein the same components will be denoted with the same reference numerals, and the description of the same technical content will be omitted. For the omitted portions, please refer to the relevant sections of the foregoing embodiment, which will not be repeated here.

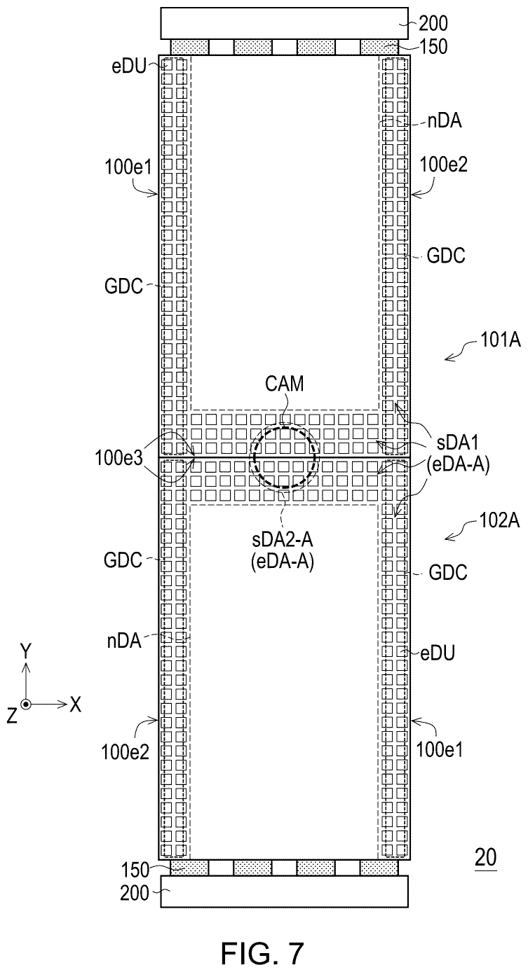

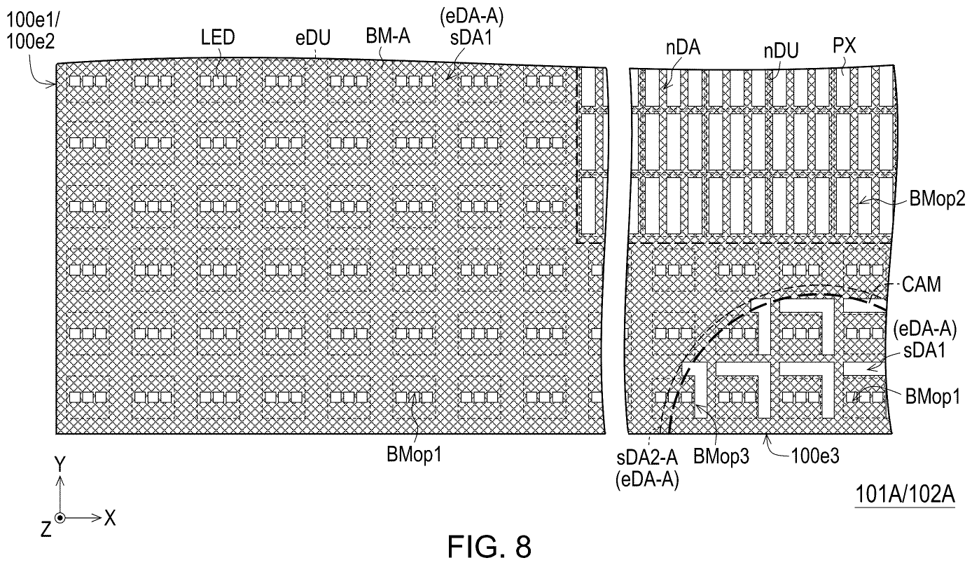

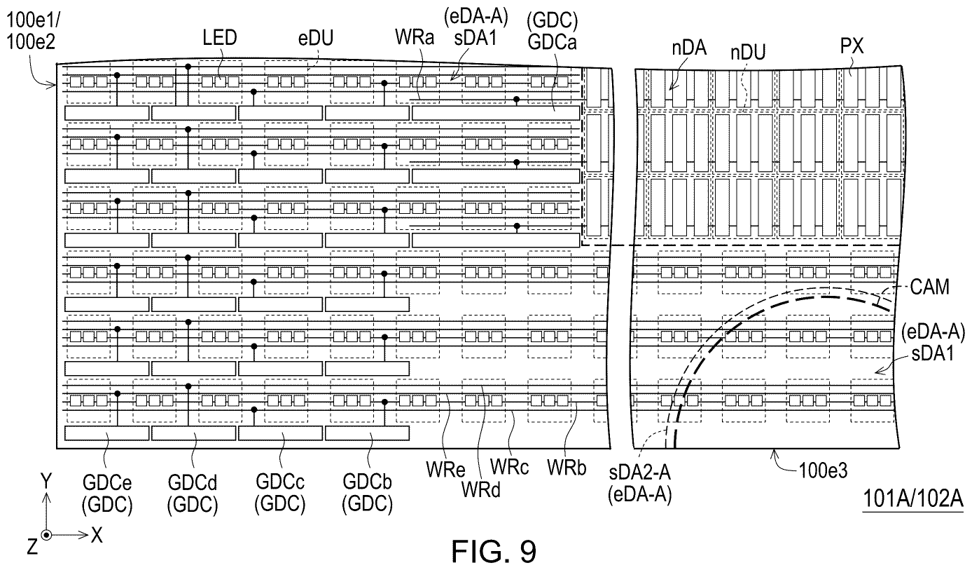

FIG. 7 is a schematic front view of a tiling display apparatus according to a second embodiment of the disclosure. FIG. 8 and FIG. 9 are enlarged schematic diagrams of a partial region of the display panel of FIG. 7. Referring to FIG. 7, FIG. 8, and FIG. 9, the difference between a tiling display apparatus 20 of the embodiment and the tiling display apparatus 10 of FIG. 1 lies in that the splicing direction of the two display panels is different. In the tiling display apparatus 20 of the embodiment, the display panel 101A and the display panel 102A are spliced together via the splicing edges 100e3.

In the embodiment, the camera unit CAM is disposed overlapping the splicing portion between the display panel 101A and the display panel 102A. That is, the camera unit CAM overlaps the splicing edges 100e3 of the display panel 101A and the display panel 102A. Correspondingly, in the embodiment, the second sub-display area sDA2-A of the self-emissive display area eDA-A is disposed between the non-self-emissive display area nDA and the splicing edge 100e3, and only the first sub-display area sDA1 is disposed between the non-self-emissive display area nDA and each of the splicing edge 100e1 and the splicing edge 100e2 of the display panel.

By disposing the camera unit CAM at the short-side splicing portion between the display panel 101A and the display panel 102A, the number of light-emitting elements LED disposed around the non-self-emissive display area nDA can be effectively reduced, thereby reducing the manufacturing cost of the tiling display apparatus 20.

Since the opening arrangement of the light-shielding layer BM-A in the non-self-emissive display area nDA, the first sub-display area sDA1 and the second sub-display area sDA2-A of the self-emissive display area eDA-A of the embodiment is similar to the opening arrangement of the light-shielding layer BM in the non-self-emissive display area nDA, the first sub-display area sDA1 and the second sub-display area sDA2 of the self-emissive display area eDA in FIG. 5, the detailed description can be found in the relevant sections of the foregoing embodiment and will not be repeated here.

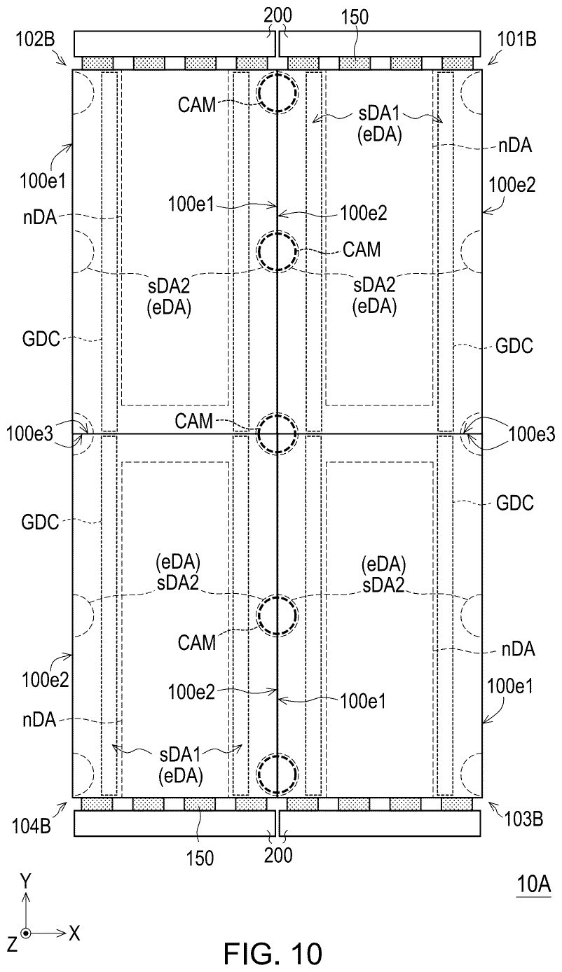

FIG. 10 is a schematic front view of a tiling display apparatus according to a third embodiment of the disclosure. Referring to FIG. 10, the difference between a tiling display apparatus 10A of the embodiment and the tiling display apparatus 10 of FIG. 1 lies in that the number of display panels to be spliced and the arrangement of the camera units are different. In the embodiment, the number of display panels to be spliced in the tiling display apparatus 10A is four. For example, a display panel 101B and a display panel 102B are spliced together along the direction X, a display panel 103B and a display panel 104B are spliced together along the direction X, the display panel 101B and the display panel 103B are spliced together along the direction Y, and the display panel 102B and the display panel 104B are spliced together along the direction Y, but the disclosure is not limited thereto.

It should be particularly noted that, in the embodiment, three camera units CAM may be disposed between two display panels (for example, the two display panels 101B and 102B or the two display panels 103B and 104B) spliced together along the direction X. For example, a camera unit CAM may be disposed at each of the upper side, middle, and lower side of the splicing portion between the display panel 101B and the display panel 102B (or between the display panel 103B and the display panel 104B), but the disclosure is not limited thereto. It should be particularly noted that one of the three camera units CAM between two display panels spliced together along the direction X may also be located between another set of two display panels spliced together along the direction X. That is, a camera unit CAM may be disposed at the splicing portion of corners of the four display panels 101B to 104B. In other words, the tiling display apparatus 10A of the embodiment may be provided with five camera units CAM.

Since the detailed structural designs of the display panel 101B, the display panel 102B, the display panel 103B, and the display panel 104B of the embodiment are similar to those of the display panel 101 and the display panel 102 of FIG. 1, the detailed description can be found in the relevant sections of the foregoing embodiment and will not be repeated here.

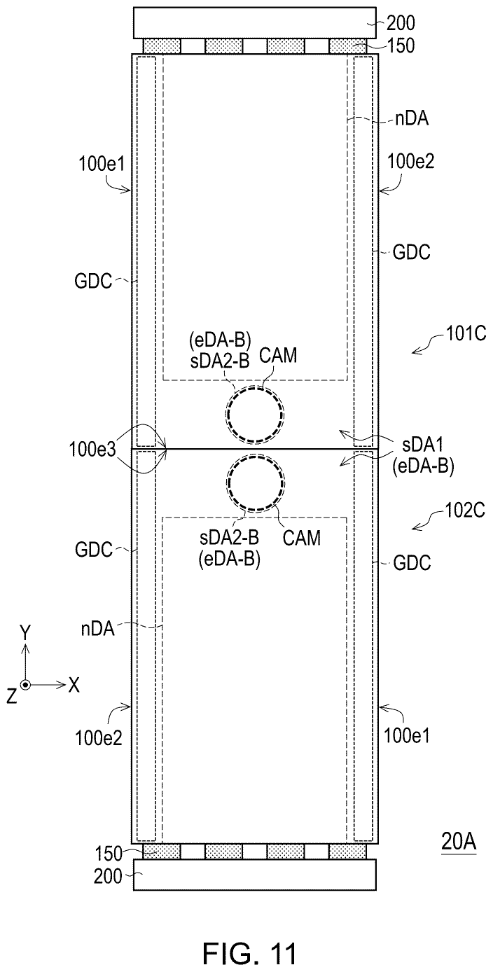

FIG. 11 is a schematic front view of a tiling display apparatus according to a fourth embodiment of the disclosure. Referring to FIG. 11, the difference between a tiling display apparatus 20A of the embodiment and the tiling display apparatus 20 of FIG. 7 lies in that the number of camera units is different. In the embodiment, the number of camera units CAM of the tiling display apparatus 20A is two, and both do not overlap the splicing portion between the display panel 101C and the display panel 102C.

More specifically, in the embodiment, any one of the camera units CAM is disposed adjacent to the splicing portion between the display panel 101C and the display panel 102C, and is entirely located in the self-emissive display area eDA-B of the display panel 101C or the display panel 102C. That is, in the embodiment, the contour of the second sub-display area sDA2-B of the self-emissive display area eDA-B in the front view direction (e.g., direction Z) of the tiling display apparatus 20A may be circular, rather than semicircular as shown in the second sub-display area sDA2 of FIG. 7.

Since the detailed structural designs of the display panel 101C and the display panel 102C of the embodiment are similar to those of the display panel 101A and the display panel 102A of FIG. 8 and FIG. 9, the detailed description can be found in the relevant sections of the foregoing embodiment and will not be repeated here.

In summary, in a tiling display apparatus of an embodiment of the disclosure, two adjacent display panels are respectively provided with a plurality of light-emitting elements in areas adjacent to the splicing edge. The arrangement of the light-emitting elements can significantly improve the continuity of the display images of the two display panels at the splicing portion. In addition, by disposing the camera unit within the distribution areas of the light-emitting elements, the concealment of the camera unit can be effectively enhanced.

What is claimed is:

1. A tiling display apparatus, comprising:
at least two display panels, spliced with each other along at least one direction, and each having a first splicing edge for splicing, wherein each of the at least two display panels is provided with a non-self-emissive display area and a self-emissive display area, the self-emissive display area extends from the first splicing edge to the non-self-emissive display area, and each of the at least two display panels comprises:
a display medium layer, disposed in the non-self-emissive display area; and
a plurality of light-emitting elements, disposed in the self-emissive display area; and
at least one camera unit, disposed in the self-emissive display areas of the at least two display panels.

2. The tiling display apparatus according to claim 1, wherein each of the at least two display panels further comprises a light-shielding layer disposed in the non-self-emissive display area and the self-emissive display area, the self-emissive display area includes a first sub-display area and a second sub-display area, the second sub-display area is located between the first sub-display area and the first splicing edge, and a first aperture ratio of the light-shielding layer in the first sub-display area is different from a second aperture ratio of the light-shielding layer in the second sub-display area.

3. The tiling display apparatus according to claim 2, wherein the at least one camera unit at least overlaps the second sub-display area of one of the at least two display panels and does not overlap the first sub-display area of each of the at least two display panels.

4. The tiling display apparatus according to claim 2, wherein the at least one camera unit overlaps a portion of the plurality of light-emitting elements of at least one of the at least two display panels.

5. The tiling display apparatus according to claim 2, wherein each of the at least two display panels further comprises:
a plurality of gate driving circuits, disposed in the first sub-display area and not overlapping the second sub-display area.

6. The tiling display apparatus according to claim 5, wherein each of the at least two display panels further comprises:
a plurality of pixel structures, disposed in the non-self-emissive display area and configured to drive the display medium layer, wherein the plurality of gate driving circuits comprise:
a plurality of first gate driving circuits, electrically coupled to the plurality of pixel structures; and
a plurality of second gate driving circuits, electrically coupled to the plurality of light-emitting elements.

7. The tiling display apparatus according to claim 2, wherein the first aperture ratio of the light-shielding layer is less than the second aperture ratio.

8. The tiling display apparatus according to claim 2, wherein the light-shielding layer has a plurality of first openings and a plurality of second openings located in the self-emissive display area, the plurality of first openings respectively overlaps the plurality of light-emitting elements, the plurality of second openings overlaps one of the at least one camera unit, and the plurality of first openings and the plurality of second openings are spaced apart from each other.

9. The tiling display apparatus according to claim 1, wherein each of the at least two display panels further has a second splicing edge for splicing, the second splicing edge is connected to and intersects the first splicing edge, each of the at least two display panels further comprises a light-shielding layer disposed in the non-self-emissive display area and the self-emissive display area, the self-emissive display area further extends from the second splicing edge to the non-self-emissive display area, the self-emissive display area includes a first sub-display area and a second sub-display area, the first sub-display area is located between the non-self-emissive display area and each of the first splicing edge and the second splicing edge, the second sub-display area is located between the non-self-emissive display area and the second splicing edge, and a first aperture ratio of the light-shielding layer in the first sub-display area is different from a second aperture ratio of the light-shielding layer in the second sub-display area.

10. The tiling display apparatus according to claim 9, wherein the at least one camera unit at least overlaps the second sub-display area of one of the at least two display panels and does not overlap the first sub-display area of each of the at least two display panels.

11. The tiling display apparatus according to claim 9, wherein each of the at least two display panels further comprises:
a plurality of gate driving circuits, disposed in the first sub-display area and not overlapping the second sub-display area.

12. The tiling display apparatus according to claim 11, wherein each of the at least two display panels further comprises:
a plurality of pixel structures, disposed in the non-self-emissive display area and configured to drive the display medium layer, wherein the plurality of gate driving circuits comprise:
a plurality of first gate driving circuits, electrically coupled to the plurality of pixel structures; and
a plurality of second gate driving circuits, electrically coupled to the plurality of light-emitting elements.

13. The tiling display apparatus according to claim 9, wherein the first aperture ratio of the light-shielding layer is less than the second aperture ratio.

14. The tiling display apparatus according to claim 1, wherein the display medium layer includes a liquid crystal layer.

15. The tiling display apparatus according to claim 1, wherein the at least one camera unit overlaps a splicing portion between two adjacent ones of the at least two display panels.

16. The tiling display apparatus according to claim 15, wherein the at least one camera unit includes a plurality of camera units.

17. The tiling display apparatus according to claim 1, wherein each of the at least one camera unit is adjacent to a splicing portion between two adjacent ones of the at least two display panels, and is entirely located in the self-emissive display area of one of the two adjacent ones of the at least two display panels.

18. A tiling display apparatus, comprising:
at least two display panels, spliced with each other along at least one direction, and each having a first splicing edge for splicing, wherein each of the at least two display panels has a non-self-emissive display area and a self-emissive display area, the self-emissive display area extends from the first splicing edge to the non-self-emissive display area, and each of the at least two display panels comprises:
a display medium layer, disposed in the non-self-emissive display area;
a plurality of light-emitting elements, disposed in the self-emissive display area; and
a first polarizer, disposed on one side of the display medium layer and overlapping the non-self-emissive display area and the self-emissive display area, wherein the display medium layer is located between the first polarizer and the plurality of light-emitting elements; and
at least one camera unit, disposed in the self-emissive display areas of the at least two display panels.

19. The tiling display apparatus according to claim 18, wherein each of the at least two display panels further comprises:
a second polarizer, disposed on another side of the display medium layer and overlapping the non-self-emissive display area, wherein the plurality of light-emitting elements are located between the second polarizer and the display medium layer.

20. The tiling display apparatus according to claim 19, wherein the self-emissive display area includes a first sub-display area and a second sub-display area, the second sub-display area is located between the first sub-display area and the first splicing edge, the at least one camera unit at least overlaps the second sub-display area of one of the at least two display panels and does not overlap the first sub-display area of each of the at least two display panels, and the second polarizer overlaps the first sub-display area and does not overlap the second sub-display area.
